(19) United States
(12) Patent Application Publication
(10) Pub. No.: US 2010/0290726 A1
(43) Pub. Date: Nov. 18, 2010

(54) Plain bearing

(75) Inventors: Michael Schlipf, Heidenheim (DE); Claudia Stern, Tannhausen (DE); Dennis Wagner, Rellingen (DE)

Correspondence Address: Mr. Edward J. Timmer, Suite 205, 121 East Front Street, Traverse City, MI, 49684, US

(73) Assignee: ElringKlinger AG

(21) Appl. No.: 12/799,043

(22) Filed: Apr. 16, 2010

(30) Foreign Application Priority Data
Apr. 17, 2009 (DE) 10 2009 018 637.9

(51) Int. Cl. F16C 33/20

(52) U.S. Cl. 384/297

(57) ABSTRACT

In order to provide a plain bearing, in which the efficiency in particular in the case of dry-running is increased and which in particular in these conditions also tolerates higher than previously usual running speeds over long periods of operation, it is proposed that the plain bearing has a bearing body, in which a bearing bush is configured, the surface of which is produced at least in some areas from a plastic material, wherein the plastic material comprises a fully fluorinated thermoplastic polymer material, optionally compounded with a proportion of one or more further high-performance thermoplastics selected from polyether ketones, polyphenylene sulphide (PPS), polyphenylene sulphone (PPSO₂), polyamide (PA), polyimide (PI), polyamide-imide (PAI) and/or polyether imide (PEI), as well as copolymers and derivatives of these polymers and copolymers.

The invention relates to a plain bearing, in particular for use as a dry-running plain bearing, with a bearing body, in which a bearing bush is configured, the surface of which is produced at least in some areas from a plastic material.

The frictional and wear behaviour is of decisive importance when designing the aforementioned plain bearings. The sliding partner of the plain bearing, generally a shaft, is frequently produced from either plastic or metal, often hardened steel.

The aforementioned plain bearings have a series of advantages:
dry-running (even in a vacuum) is possible over extended periods of operation;
chemical stability can be adapted to the respective application by selection or a modification of the plastic material;
wide structural variety and integration ability of the plain bearings;
thermal and electrical insulation is possible without problem;
mechanical damping can be adapted to the respective requirements.

Above all, the following problems arise in practice with the aforementioned plain bearings:
sliding abrasion
melting of running surfaces
bearing deformation to partial melting of bearing.

Material pairings moved relative to one another in a force-transmitting manner, as is predominantly the case with plain bearings, are generally subject to friction and wear phenomena. The two main influencing factors in friction between solid bodies are adhesion and deformation in the contact area. Thus, the coefficient of friction is composed of an adhesion component, which is proportional to the real contact area and increases, the higher the polarity and the smoother the surface, and a deformation component, which increases as the roughness and thus the penetration depth increase.

Since plastics are generally poor heat conductors, the slide face frequently has a higher temperature than the whole bearing. While the slide face, as the heat development location, determines the coefficient of friction and the wear, the mechanical loading capacity of the slide pairing is primarily defined by the bearing temperature.

In the case of sliding friction, a stick-slip effect is often observed that often occurs when the static coefficient of friction (resting friction coefficient) is higher than the dynamic (coefficient of sliding friction) or when the coefficient of friction decreases as the sliding speed increases in an oscillatory system.

Conventional plain bearings that are designed for high loads are frequently produced by compounding using PTFE, possibly with high-performance thermoplastics, wherein still further slip additives, e.g. BN or MoS₂, can additionally be processed and contained in the compound. PEEK, PPS or PA in conjunction with PTFE are frequently used as such high-performance thermoplastics.

High proportions of PTFE in the compound as well as naturally the sole use of PTFE optimise the sliding friction of the plain bearing. However, the cold flow properties of PTFE that in many cases lead to inadequate service lives are problematic.

Longer services lives are desirable in numerous applications, in particular in cases in which replacement of the plain bearing can only be implemented with high expense and correspondingly long interruptions to operation or where safety risks render early replacement necessary.

The use of fillers, e.g. glass, bronze and carbon particles, can improve the cold flow behaviour of standard PTFE as well as chemically modified PTFE, but substantial contents are necessary for this in some instances, which can in turn have a negative influence on other properties of PTFE, e.g. the mechanical properties, the coefficient of friction as well as the resistance to chemicals. Some typical materials based on standard PTFE and chemically modified PTFE are listed in Table 1.

TABLE 1

| | | Filler Content | Cold Flow [%] |
|---|---|---|---|
| Plastic Material | Filler | [% by wt.] | (permanent) |
| Standard PTFE | — | — | 11 |
| | Glass particles | 15 | 9.5 |
| | | 25 | 8.5 |
| | Bronze particles | 60 | 4.7 |
| | (irregular form) | | |
| | Carbon particles | 25 | 4.4 |
| Chemically | — | — | 4.2 |
| modified | Glass particles | 15 | 3.7 |
| PTFE | | 25 | 3.1 |
| | Bronze particles | 60 | 2.8 |
| | Carbon particles | 25 | 2.6 |

The cold flow values specified in Table 1 were determined at 23° C. with a pressure load of 15 N/mm² over 100 h and after 24 h of pressure relief.

The above-mentioned standard PTFE characterised in its cold flow properties is Teflon® 701 from DuPont, the chemically modified PTFE is a PTFE copolymer with a PPVE comonomer content of 0.15% by weight. These material definitions will also be referred to in the following parts of the description.

It is an object of the invention to provide a plain bearing, in which the efficiency in particular in the case of dry-running is increased and which in particular in these conditions also tolerates higher than previously usual sliding speeds over long periods of operation.

This object is achieved by plain bearings according to claim 1.

In the case of fully fluorinated thermoplastic polymer materials, which differ from chemically modified PTFE primarily by a higher and possibly also different proportion of comonomer and only have slightly lower melting points, significantly improved cold flow properties surprisingly occur, and more surprisingly these are accompanied by drastically improved wear properties.

Thus, for Moldflon® materials with PPVE comonomer contents of 0.2 to 1 mole %, for example, one finds a melting point of 323° to 315° C. compared to 327° C. for standard and chemically modified PTFE. Thus, the application temperature can still also lie at 250° C. and above in the case of the Moldflon® materials.

On the other hand, cold flow values of approximately 2.4% are obtained for these Moldflon® materials without fillers having to be used.

Circumferential speeds of more than 5 m/s can be achieved with the plain bearings according to the invention, which lie far above the permissible maximum circumferential speeds for standard PTFE and chemically modified PTFE (standard PTFE at best approximately 2.5 m/s; chemically modified PTFE at best approximately 3.5 m/s).

Since the fully fluorinated thermoplastic polymer materials still exhibit a universal resistance to chemicals, the plain bearings according to the invention can be used in applications that were closed to previous plain bearings based on standard PTFE and chemically modified PTFE.

The insensitivity to edge pressure as well as the absence of corrosion and lack of moisture absorption and the possibility of FDA approval also open a wide variety of fields of application to the plain bearings according to the invention.

TFE copolymers, in which the comonomer has a minimum proportion of 0.2 mole %, can be employed in particular as fully fluorinated thermoplastic plastic materials. The comonomer is preferably selected from hexafluoropropylene, perfluoroalkyl vinyl ether, perfluoro-(2,2-dimethyl-1,3-dioxol) and chlorotrifluoroethylene.

Copolymers of TFE with chlorotrifluoroethylene are also included under fully fluorinated plastic materials in the context of the present invention, since the proportion of halogen other than fluorine is comparatively low.

A comonomer of the polyalkyl vinyl ether type frequently to be used within the framework of the invention is perfluoropropyl vinyl ether (PPVE). Proportions of less than 3.5 mole % are recommended in the case of this comonomer, since the PTFE properties are substantially retained here and thermoplastic processing is nevertheless possible. It is further preferred if the proportion of comonomer is limited to less than approximately 3 mole %, and proportions of comonomer of less than approximately 2.5 mole %, e.g. 1 mole % or less or 0.5 mole % or less, are still further preferred.

The use of thermoplastically workable PTFE, also melt-processable PTFE or m-PTFE for short, is particularly preferred. A plurality of such materials are described in WO 01/60911 and WO 03/078481, for example.

PFA also represents a suitable fully fluorinated thermoplastically workable plastic material in the sense of the present invention.

Besides the TFE copolymers, polymer blends of PTFE and one or more further thermoplastically workable fluorinated plastics are usable as fully halogenated, in particular fully fluorinated, plastic material that can be used according to the invention.

These further fully halogenated plastic materials are selected in particular from the group of PTFE micropowders. These are PTFE types with a low molecular weight and low melt viscosity compared to high-molecular (standard) PTFE. They are typically produced either by emulsion polymerisation, by thermomechanical degradation of high-molecular PTFE in the extruder or by radiation degradation of high-molecular PTFE, followed by a grinding process.

The differences in properties of conventional or high-molecular (standard) PTFE and low-molecular PTFE micropowders can be represented, for example, as follows (cf. S. Ebnesajjad, Fluoroplastics, vol. 1, Non-Melt Processible Fluoro-Plastics, William Andrew Publishing, 2000):

| | | Melt Viscosity at 380° C. in |
|---|---|---|
| Product | Molecular Weight | Pa · s |
| Standard PTFE | approx. 10⁶-approx. 10⁸ | approx. 10¹⁰-approx. 10¹³ |
| Micropowder | approx. 10⁴-approx. 10⁶ | approx. 10²-approx. 10⁵ |

Examples for such polymer blends can also be found in published documents WO 01/60911 and WO 03/078481.

It is worth emphasising the property of the plastic materials usable according to the invention of being easily workable on CNC cutting machines. This opens up new production processes for the plain bearings according to the invention.

Preferred plastic materials usable according to the invention can contain additives, in particular in quantities of up to 60% by weight in relation to the total mass of the compound. Particularly preferred compounds usable according to the invention contain up to 40% by weight in additives.

Typical lower limits for additives lie at approximately 0.5% by weight.

If the plastic material contains colouring agents as additives, the lower limit for this type of additive typically lies at approximately 0.01% by weight. The upper limit for proportions of colouring agent in the plastic material typically lies at approximately 3% by weight.

In addition, both organic and inorganic fillers can be employed as additives.

The fillers can be present in particular in fibre, granular or needle form.

Functional fillers such as e.g. solid lubricants such as BN, SiC, MoS₂, graphite, bronze, carbon black, carbon fibres and the like, for example, are particularly preferred. Such plastic materials usable according to the invention have improved mechanical properties as a result of filler contents, whereas the advantageous properties of the fully fluorinated polymer material do not deteriorate to a disturbing extent if the proportions of the fillers remain within the limits outlined above.

If compounds comprising fully fluorinated thermoplastic polymer material and one or more high-performance thermoplastics are used in the plain bearings according to the invention, the proportion of the further high-performance polymers in the total mass of the compound usable according to the invention preferably amounts to 3% by weight or more. The improvement in properties below such a proportion is not particularly pronounced in some instances.

On the other hand, the proportion of the fully fluorinated thermoplastically workable polymer in the total mass of the compound should preferably amount to 3% by weight or more. This ensures that the sliding properties of the fully fluorinated plastic material are still noticeable.

Because of the selection of the PTFE component as fully halogenated, in particular fully fluorinated, thermoplastic plastic material, the compound can be obtained with a high homogeneity in structural configuration.

This is particularly apparent in that in the case of the compounds usable according to the invention the individual components are no longer identifiable as the original mixture of two substances in powder form in the solidified end product after processing using the usual methods for thermoplastics, i.e. by means of extrusion or injection moulding processes, for example.

In contrast to the compounds usable according to the invention, phases of the individual components can be detected in conventional compounds by means of special methods, e.g. staining techniques in association with a light-optical microscope, or by using polarised light. Depending on the type of PTFE used, larger or smaller PTFE island structures are retained in the compound, with typical extents of approximately 0.2 μm or more in the case of emulsion-polymerised PTFE, with typical extents of approximately 15 μm or more in the case of suspension-polymerised PTFE.

In comparison, the compound usable according to the invention is substantially free from PTFE island structures.

In the case of the compounds usable according to the invention the restriction of the mixture ratios, that is substantial with standard PTFE compounds, is not necessary with the further high-performance polymers.

The composition of the compound can be widely varied with respect to the proportions of fully fluorinated thermoplastic plastic material, in particular melt-processable PTFE, and also the further high-performance polymer component(s).

Surprisingly, the compounds usable according to the invention exhibit considerably improved mechanical properties compared to the conventional PTFE compounds.

In particular, compounds usable according to the invention containing a high proportion of further high-performance polymer and a lower proportion of thermoplastically workable PTFE can be produced with a high percent elongation at failure, i.e. elongation at failure values of 20% and more, for example, further preferred 30% and more. The specified elongation at failure values correspond to values from tests in accordance with DIN EN ISO 527-1 using V type test pieces in accordance with ASTM D-638.

These properties are required in particular when the typical property spectrum of the pure component of the high-performance polymers, i.e. a high E-modulus, a high deformation resistance and a high breaking strength, is required, while the high brittleness of the high-performance polymer prevents successful use.

PTFE materials, in particular even standard PTFE, naturally have higher elongation at failure values than the further high-performance polymers. However, a drastic drop in the elongation at failure values is also observed here as proportions thereof increase in the compound.

In comparison, with the same ratios of the proportions of fully fluorinated polymer material to further high-performance polymer, in particular also PI or PPS, the compounds usable according to the invention have clearly more favourable elongation at failure values, which are of great importance in many plain bearing applications.

Moreover, the compounds usable according to the invention are suitable for the production of high-temperature-resistant structural parts, which exhibit a favourable behaviour in fire. Such structural parts are of great interest in aircraft construction.

Moreover, the compounds usable according to the invention are eminently suitable for injection moulding production, wherein in particular the high mechanical strength of the structural parts obtained with respect to the pressure and tensile loads are of advantage. The higher stability under pressure in the case of long-term pressure load both at room temperature and at temperatures up to 250° C. is of great advantage.

Moreover, compounds usable according to the invention can be produced with improved sliding properties, wherein a stick-slip effect can be avoided while the coefficient of friction is very low, in particular in the case of the compounds according to the invention with a high proportion of melt-processable PTFE. With a sliding speed of V=0.6 m/s and a load perpendicular to the sliding direction of 0.5 to 1.5 N/mm² coefficients of friction in the range of 0.1 to 0.3 are possible here.

One of the consequences of the low coefficient of friction is the low wear values of the compounds usable according to the invention. This is also important for the plain bearing application.

In addition, structural parts made from the compounds usable according to the invention are also suitable for higher specific surface pressures, exhibit lower abrasion and thus a longer service life. An important property for plain bearing applications is again present here.

The aforementioned advantages of the compounds according to the invention with fully fluorinated thermoplastic polymer materials, in particular m-PTFE, apply in comparison to compounds, which with the same percentage composition contain standard PTFE or chemically modified high-molecular PTFE as fully fluorinated components.

The compounds usable according to the invention are preferably produced by means of melt-compounding.

These and further advantages of the invention will be explained in more detail below on the basis of examples and figures.

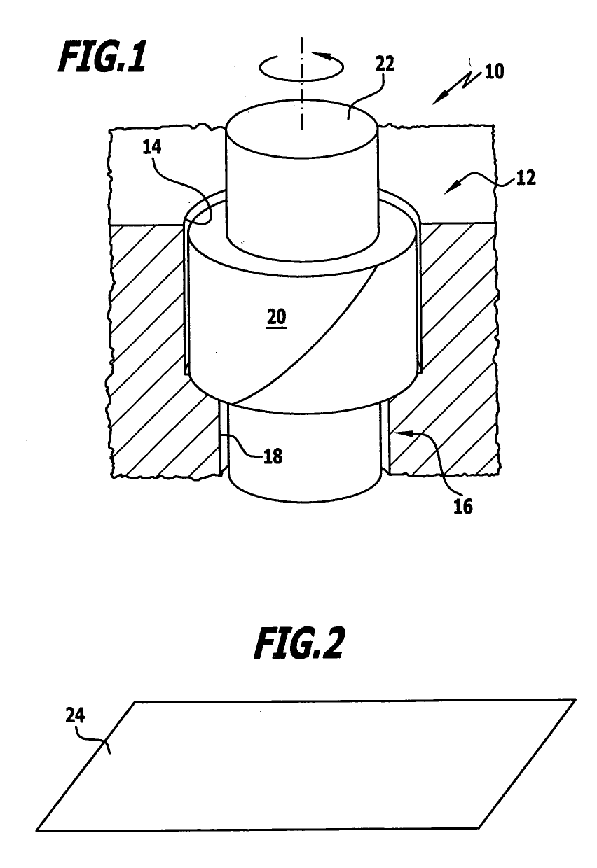

FIG. 1 is a schematic representation of a test apparatus for plain bearings according to the invention;

FIG. 2 shows a section of film for forming a plain bearing according to the invention;

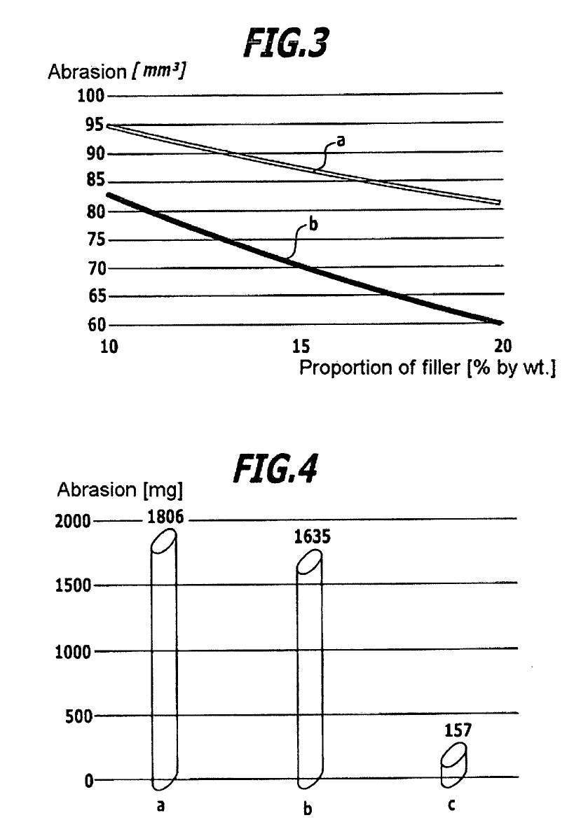

FIG. 3 is a graphic representation of the results of pin on disc abrasion tests; and

FIG. 4 is a graphic representation of the results of pin on shaft abrasion tests.

### EXAMPLES

### Example 1

A plain bearing in the form of a plain bearing sleeve produced from 100% by weight of Moldflon® MF10005, such as may be used, for example, in stirring mechanisms in ice-cream machines, is tested for wear at room temperature in a test apparatus (FIG. 1) in continuous operation for 2 weeks at 12 000 min⁻¹.

The plastic material Moldflon® MF10005 is a so-called m-PTFE with a proportion of comonomer of 1.7% by weight of the comonomer PPVE. The melt flow rate MFR (372/5) amounts to 5 g/10 min.

The test apparatus 10 of FIG. 1 comprises a bearing block 12 with a bearing seating 14, which extends through the entire bearing block 12. The bearing seating 14 has a projection 18 at its lower end 16 that forms a support for a plain bearing sleeve 20 inserted into the bearing seating 14. The plain bearing sleeve has a wall thickness of 1 mm. The height of the plain bearing sleeve amounts to 6 mm. The free diameter of the plain bearing sleeve amounts to 10 mm.

In the test the plain bearing sleeve 20 receives a shaft 22, which has a diameter of 10 mm and is produced from special steel (type X210Cr12).

The plain bearing sleeve 20 is formed by rolling up from a piece of film 24 (cf. FIG. 2) stamped out of a fusion-extruded 1 mm thick film of Moldflon® MF10005 in the parallelogram shape shown in FIG. 2 and is then inserted into the bearing seating 14.

The plain bearing thus produced also exhibits no traces of wear after 2 weeks of continuous operation.

### Comparative Example 1

For comparison, a piece of film with the same dimensions as in the above example was stamped out of a film with a thickness of 1 mm peeled from a cylinder of sintered standard PTFE material (Teflon® 701 from DuPont), rolled up and likewise subjected as plain bearing sleeve to a test in the test apparatus 10. The test conditions were the same as in the case of the plain bearing according to the invention. After 2 weeks of continuous operation, the plain bearing was worn to such an extent that it had to be replaced.

### Example 2

For plain bearings (bush or flanged bush) according to ISO 3547-1 according to the present invention, the maximum operating data of Table 2 result for the plastic material compositions a, b and c.

TABLE 2

| Properties | a | b | c |
|---|---|---|---|
| Max. circumferential | >5 | 1.5 | 1.5 |
| speed in dry-running | | | |
| [m/s] | | | |
| Max. static surface | 15 | 45 | 80 |
| pressure [N/mm²] | | | |
| Temperature range of | −250 to +250 | −250 to +250 | −250 to +250 |
| application [° C.] | | | |

The plastic material compositions a, b and c were as follows:
a: 100% by weight of Moldflon ® MF10005
b: 60% by weight of Moldflon ® MF10010, 30% by weight of PEEK, 10% by weight of carbon fibres
c: 20% by weight of Moldflon ® MF10005, 80% by weight of PEEK Moldflon ® MF10010 differs from Moldflon ® MF10005 by a higher MFR value of 10 g/min, while the comonomer content is identical in both types.

### Example 3

In Example 3 the results of wear tests of plastic materials based on standard PTFE (sample a) and m-PTFE (sample b) with different contents of carbon fibres were compared. Moldflon® MF10005 was used as m-PTFE.

Pins of plastic material with a diameter of 10 mm were used as test pieces. These were pressed against a disc of special steel (X210Cr12) with a force of 0.42 N/mm². The surface roughness Rz of the steel disc amounted to 2 μm. The temperature of the steel disc was 100° C., the relative speed amounted to 4 m/s. The test period amounted to 100 h in each case. Test atmosphere: air. Testing was conducted in accordance with DIN ISO 7148-2.

The test results for carbon fibre contents of 10 to 20% by weight can be seen from the graphs in FIG. 3.

### Example 4

In Example 4 the results of wear tests of plastic materials in the form of standard PTFE (sample a), modified PTFE (sample b) and m-PTFE (Moldflon® MF10005) (sample c) were compared.

A pin with a diameter of 10 mm was used as test piece. It was pressed against a shaft of special steel (X210Cr12) with a surface roughness Rz of 1.91 μm with a force of 0.21 N/mm². The sliding speed between the shaft and pin during the test amounted to 4 m/s, the test atmosphere was air and the test temperature 100° C. Testing was conducted in accordance with DIN ISO 7148-2.

The test results for a test period of 1 h can be seen from the graphs in FIG. 4.

1. Plain bearing, in particular dry-running plain bearing, with a bearing body, in which a bearing bush is configured, the surface of which is produced at least in some areas from a plastic material, wherein the plastic material comprises a fully fluorinated thermoplastic polymer material, optionally compounded with a proportion of one or more further high-performance thermoplastics selected from polyether ketones, polyphenylene sulphide (PPS), polyphenylene sulphone (PPSO₂), polyamide (PA), polyimide (PI), polyamide-imide (PAI) and/or polyether imide (PEI), as well as copolymers and derivatives of these polymers and copolymers.

2. Plain bearing according to claim 1, characterised in that the plastic material is substantially composed of the fully fluorinated thermoplastic polymer material.

3. Plain bearing according to claim 1, characterised in that the plastic material is a compound with a homogeneous distribution of the proportions of the fully fluorinated thermoplastic polymer material and the further high-performance thermoplastic or thermoplastics.

4. Plain bearing according to claim 3, characterised in that the proportion of the fully fluorinated thermoplastic polymer material in the plastic material amounts to approximately 3% by weight or more.

5. Plain bearing according to claim 4, characterised in that the proportion of the fully fluorinated thermoplastic polymer material in the plastic material amounts to approximately 97% by weight or less.

6. Plain bearing according to claim 3, characterised in that the polyether ketone is selected from the group of polyether ketone (PEK), polyether ether ketone (PEEK) and polyether aryl ketone (PEAK) as well as copolymers and derivatives of these polymers.

7. Plain bearing according to claim 3, characterised in that the PPS and/or the PPSO₂, is a chemically modified PPS or PPSO₂.

8. Plain bearing according to claim 3, characterised in that the polyamide (PA) is a high-temperature polyamide (HTPA), in particular a polyarylamide and/or a polyphthalamide and/or polyisophthalamide.

9. Plain bearing according to claim 3, characterised in that the plastic material is produced as a compound by way of melt-compounding.

10. Plain bearing according to claim 9, characterised in that the compound is substantially pre-free.

11. Plain bearing according to claim 1, characterised in that the fully fluorinated thermoplastically workable polymer material comprises melt-processable PTFE.

12. Plain bearing according to claim 11, characterised in that the melt-processable PTFE comprises a TFE copolymer, wherein the comonomer is contained in a proportion of approximately 0.2% mole % or more.

13. Plain bearing according to claim 12, characterised in that the comonomer is selected from hexafluoropropylene, perfluoroalkyl vinyl ether, perfluoro-(2,2-dimethyl-1,3-dioxol) and chlorotrifluoroethylene.

14. Plain bearing according to claim 13, characterised in that the comonomer is PPVE and is contained in the TFE copolymer with a content of approximately 0.2 to less than 3.5 mole %.

15. Plain bearing according to claim 1, characterised in that the plastic material comprises additives.

16. Plain bearing according to claim 15, characterised in that one or more fillers are contained as additives.

17. Plain bearing according to claim 16, characterised in that the filler or fillers are selected from BN, SiC, MoS₂ carbon fibres, bronze, carbon black and graphite.

18. Plain bearing according to claim 1, characterised in that the bearing body is substantially composed completely of the plastic material.

19. Plain bearing according to claim 1, characterised in that the bearing body comprises a metal structural part, which contains the bearing bush, which is coated at least in some areas with the plastic material.

20. Plain bearing according to claim 19, characterised in that the plastic material is applied to the metal structural part by lamination or direct extrusion thereon.

21. Plain bearing according to claim 19 or 20, characterised in that the metal structural part is a steel part or a bronze part.

22. Plain bearing according to claim 19, characterised in that the metal structural part comprises an element composed of a metal fabric or a metal braid.

23. Plain bearing according to claim 1, characterised in that the plain bearing is produced in an injection moulding process or by means of a machining step.

24. Use of a plain bearing according to claim 1 as a dry-running plain bearing.

25. Use of a plain bearing according to claim 1 as a plain bearing under vacuum conditions.
